(19) United States
(12) Patent Application Publication
(10) Pub. No.: US 2009/0251029 A1
(43) Pub. Date: Oct. 8, 2009

(54) STATOR CAN HOUSING WELDED TO BEARING SUPPORT AND METHOD OF ASSEMBLING A HYBRID TRANSMISSION UTILIZING THE SAME

(75) Inventors: Timothy J. Reinhart, Brownsburg, IN (US); Gregory W. Kempf, Avon, IN (US); Kenneth D. Schoch, Greenwood, IN (US); William S. Reed, Greenfield, IN (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/193,849

(22) Filed: Aug. 19, 2008

Related U.S. Application Data
(60) Provisional application No. 61/041,935, filed on Apr. 3, 2008.

(51) Int. Cl. H02K 5/16; H02K 15/02; H02K 5/00

(52) U.S. Cl. 310/425; 29/596; 903/906

(57) ABSTRACT

A motor/generator for a hybrid transmission includes a bearing support configured for attachment to the hybrid transmission. A stator can is bonded directly to the bearing support, possibly by welding. The motor/generator may further include a stator press-fit into said stator can. A method of assembling a hybrid transmission includes welding a stator can to a bearing support, forming a motor/generator housing. A stator is then pressed into the housing. A substantially-complete motor/generator is assembled by installing a rotor, a rotor hub, and a ball bearing into the housing, which are held in the motor/generator housing with a snap ring. The method may include rigidly attaching the substantially-complete motor/generator to a main case. The method may further include testing the substantially-complete motor/generator prior to transporting the motor/generator to a final place of assembly and rigidly attaching the motor/generator to the transmission main case.

### CROSS-REFERENCE TO RELATED APPLICATIONS

This application claims the benefit of U.S. Provisional Application No. 61/041,935, filed Apr. 3, 2008, which is hereby incorporated by reference in its entirety.

### TECHNICAL FIELD

The present invention relates to vehicular drivetrains, and more particularly, to transmissions for hybrid and hybrid-type vehicles.

### BACKGROUND OF THE INVENTION

Internal combustion engines, particularly those of the reciprocating piston type, currently propel most vehicles. Such engines are relatively efficient, compact, lightweight, and inexpensive mechanisms by which to convert highly concentrated energy in the form of fuel into useful mechanical power.

Typically, a vehicle is propelled by such an engine, which is started from a cold state by a small electric motor and relatively small electric storage batteries, then quickly placed under the loads from propulsion and accessory equipment. Such an engine is also operated through a wide range of speeds and a wide range of loads and typically at an average of approximately a fifth of its maximum power output.

A vehicle transmission typically delivers mechanical power from an engine to the remainder of a drive system, such as fixed final drive gearing, axles and wheels. A typical mechanical transmission allows some freedom in engine operation, usually through alternate selection of five or six different drive ratios, a neutral selection that allows the engine to operate accessories with the vehicle stationary, and clutches or a torque converter for smooth transitions between driving ratios and to start the vehicle from rest with the engine turning. Transmission gear selection typically allows power from the engine to be delivered to the rest of the drive system with a ratio of torque multiplication and speed reduction, with a ratio of torque reduction and speed multiplication known as overdrive, or with a reverse ratio.

To operate properly, the transmission usually requires a supply of pressurized fluid, such as conventional transmission oil. The pressurized fluid may be used for such functions as cooling, lubrication, and, in some cases, operation of the torque transfer devices. The lubricating and cooling capabilities of transmission oil systems impact the reliability and durability of the transmission. Additionally, multi-speed transmissions require pressurized fluid for controlled engagement and disengagement of the torque transmitting mechanisms that operate to establish the speed ratios within the internal gear arrangement.

In hybrid vehicles, alternative power is available to propel the vehicle, minimizing reliance on the engine for power, thereby increasing fuel economy. Since hybrid vehicles can derive their power from sources other than the engine, engines in hybrid vehicles can be turned off while the vehicle is propelled by the alternative power source(s). For example, electrically variable transmissions alternatively rely on electric motors housed in the transmission to power the vehicle's driveline.

An electric generator can transform mechanical power from the engine into electrical power, and an electric motor can transform that electric power back into mechanical power at different torques and speeds for the remainder of the vehicle drive system. These functions may be combined into a single electric machine, a motor/generator. An electric storage battery used as a source of power for propulsion may also be used, allowing storage of electrical power created by the generator, which may then be directed to the electric motor for propulsion or used to power accessory equipment.

A series hybrid system allows the engine to operate with some independence from the torque, speed and power required to propel a vehicle, so the engine may be controlled for improved emissions and efficiency. Such a system may also allow the electric machine attached to the engine to act as a motor to start the engine. This system may also allow the electric machine attached to the remainder of the drive train to act as a generator, recovering energy from slowing the vehicle and storing it in the battery by regenerative braking.

An electrically variable transmission in a vehicle can simply transmit mechanical power from an engine input to a final drive output. To do so, the electric power produced by one motor/generator balances the electrical losses and the electric power consumed by the other motor/generator. By using the above-referenced electrical storage battery, the electric power generated by one motor/generator can be greater than or less than the electric power consumed by the other. Electric power from the battery can allow both motor/generators to act as motors. Both motors can sometimes act as generators to recharge the battery, especially in regenerative vehicle braking.

A power-split transmission can use what is commonly understood to be “differential gearing” to achieve a continuously variable torque and speed ratio between input and output. An electrically variable transmission can use differential gearing to send a fraction of its transmitted power through a pair of electric motor/generators. The remainder of its power flows through another, parallel path that is mechanical.

One form of differential gearing, as is well known to those skilled in this art, may constitute a planetary gear set. However, it is possible to construct this invention without planetary gears, as by using bevel gears or other gears in an arrangement where the rotational speed of at least one element of a gear set is always a weighted average of speeds of two other elements.

A hybrid electric vehicle transmission system may include one or more electric energy storage devices. The typical device is a chemical electric storage battery, but capacitive or mechanical devices, such as an electrically driven flywheel, may also be included. Electric energy storage allows the mechanical output power from the transmission system to the vehicle to vary from the mechanical input power from the engine to the transmission system. The battery or other device also allows for engine starting with the transmission system and for regenerative vehicle braking.

### SUMMARY OF THE INVENTION

A motor/generator for a hybrid transmission is provided, including a bearing support configured for attachment to the hybrid transmission and a stator can, which is bonded directly to the bearing support. The stator can may be directly bonded to the bearing support by welding. The motor/generator may further include a stator press-fit into a tubular portion of the stator can.

A method of assembling a hybrid transmission is also provided. The method includes providing a stator can and a bearing support, and welding the stator can to the bearing support, forming a motor/generator housing. A stator is then pressed into this motor/generator housing. A substantially-complete motor/generator is assembled by installing a rotor, a rotor hub, and a ball bearing into the motor/generator housing. The rotor, rotor hub, and ball bearing may be held in the motor/generator housing with a snap ring.

The method may include providing a transmission main case and rigidly attaching the substantially-complete motor/generator to the transmission main case. The method may further include testing the assembled substantially-complete motor/generator prior to rigidly attaching the motor/generator to the transmission main case. Additionally, the motor/generator may be assembled at a first facility and then transported to a second facility, where it may then be rigidly attached to the transmission main case.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic representation of a powertrain into which one embodiment of the present invention may be incorporated;

FIG. 2 is a schematic cross-sectional view of a portion of an embodiment of a hybrid transmission, showing the relative locations of the input shaft, motor A, and motor B; and

FIG. 3 is a more-detailed, cross-sectional view of a portion of the motor B shown schematically in FIG. 2.

### DESCRIPTION OF PREFERRED EMBODIMENTS

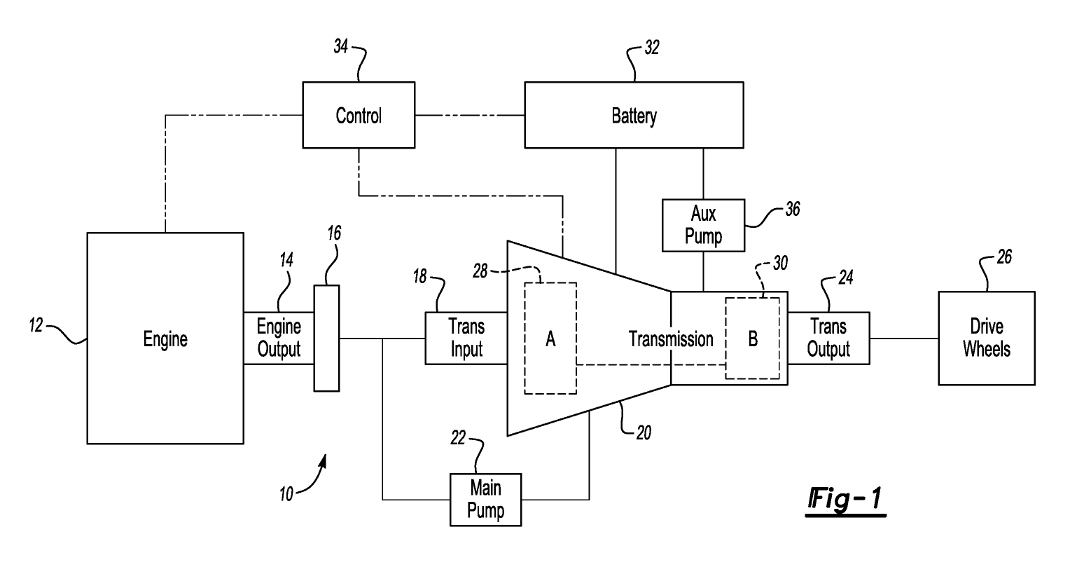

With reference to FIG. 1, there is shown a schematic diagram of a powertrain 10 into which the claimed invention may be incorporated. The powertrain 10 includes an engine 12, which may be any type of internal combustion engine known in the art, turning an engine output 14, which transmits the driving power produced by the engine 12. Driving power is then transferred through a transmission input shaft 18 into a transmission 20. In some embodiments, a damper 16 may be interposed between the engine output 14 and the transmission input shaft 18, or otherwise included in engine output 14.

Input shaft 18 may be operatively connectable to planetary gear members (not shown) or to torque transfer devices (not shown) within transmission 20. The transmission 20 may be an electrically variable transmission, a one or two-mode input split transmission, a two-mode transmission with input-split and compound-split, or another hybrid transmission known to those having ordinary skill in the art.

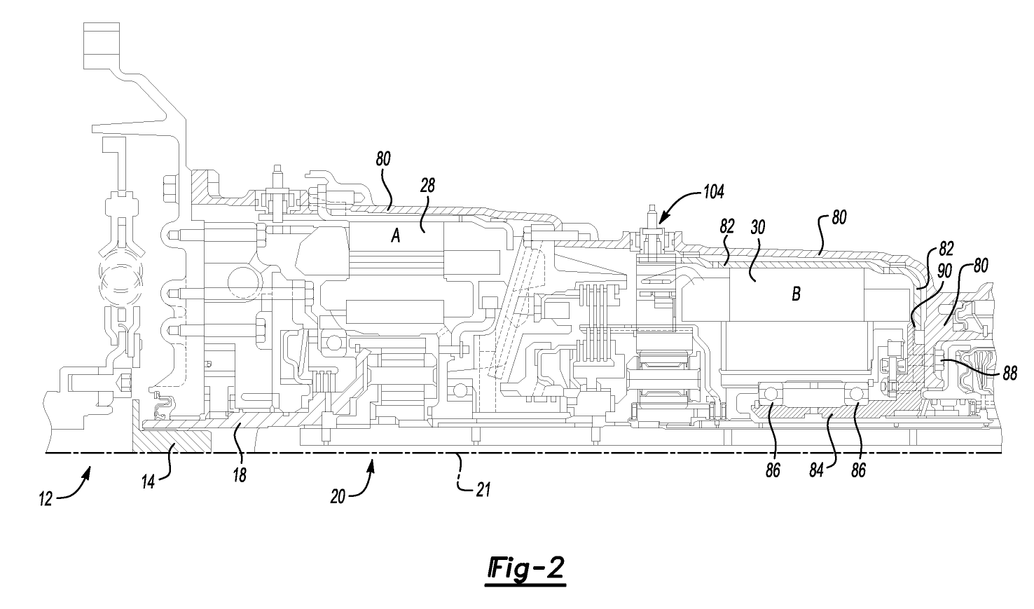

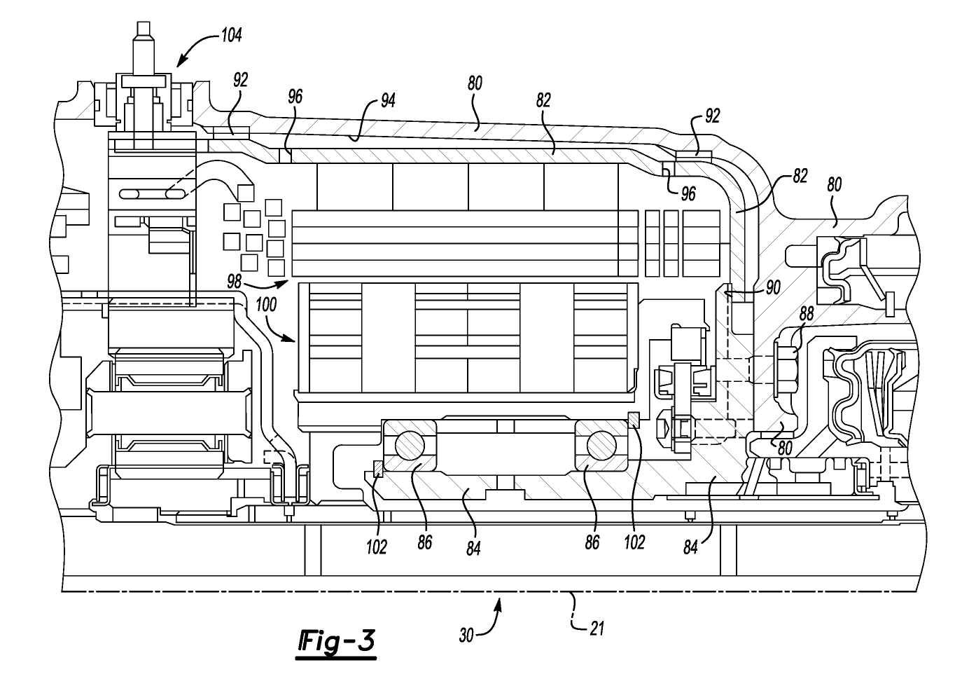

Transmission 20 utilizes input shaft 18 to receive power from the vehicle engine 12 and a transmission output 24 to deliver power to drive the vehicle through one or more drive wheels 26. Transmission 20 includes a first motor 28 and a second motor 30. Each of the motors 28 and 30 is a motor/generator capable of both converting electric power into mechanical power and converting mechanical power into electric power. The first motor 28 may also be referred to as motor A, and second motor 30 may be referred to as motor B. Second motor 30 (motor B) will described in more detail below, with reference to FIGS. 2 and 3.

The fluid in transmission 20 is pressurized by a main pump 22. The pressurized fluid may be used for such functions as cooling, lubrication, and, in some cases, operation of the torque transfer devices. Most transmission pumps are directly or indirectly driven by rotation of the engine output member—such as the engine crankshaft, engine driven damper, or torque converter assembly drive hub—to drive the pump rotor.

The transmission 20 may utilize one or planetary gear sets (not shown), and may utilize one or more clutches (not shown) to provide input split, compound split, and fixed ratio modes of operation. The planetary gear sets may be simple or may be individually compounded.

The motors 28 and 30 are operatively connected to a battery 32, an energy storage device, so that the battery 32 can accept power from, and supply power to, the first and second motor/generators 28 and 30. A control system 34 regulates power flow among the battery 32 and the motors 28 and 30, as well as between the motors 28 and 30.

As will be apparent to those having ordinary skill in the art, the control system 34 may further control the engine 12 and operation of the transmission 20 to select the output characteristics transferred to the drive wheels 26. Control system 34 may incorporate multiple control methods and devices.

As will further be recognized by those having ordinary skill in the art, battery 32 may be a single chemical battery or battery pack, multiple chemical batteries, or other energy storage device suitable for hybrid vehicles. Other electric power sources, such as fuel cells, that have the ability to provide, or store and dispense, electric power may be used in place of battery 32 without altering the concepts of the present invention.

In some modes of operation for the powertrain 10, the engine 12 may shut down or turn off completely. This may occur when the control system 34 determines that conditions are suitable for drive wheels 26 to be driven, if at all, solely by alternative power from one or both of motors 28 and 30, or during periods of regenerative braking. While the engine 12 is shut down, the main pump 22 is not being driven, and is therefore not providing pressurized fluid to transmission 20. Powertrain 10 may therefore include an auxiliary pump 36, which may be powered by the battery 32 to provide pressurized fluid to transmission 20 when additional pressure is required.

Referring now to FIG. 2, there is shown one possible embodiment of a portion of the powertrain 10 shown schematically in FIG. 1. More specifically, FIG. 2 shows a cross-sectional view of a portion of the upper half of transmission 20, which is an exemplary transmission into which the features of the claimed invention may be incorporated. In this embodiment of powertrain 10, the engine 12 is transferring power through an engine output 14, which may be a crank shaft, a damper hub, or another shaft-type output member capable of transferring power to the transmission 20. Power is transferred to the transmission 20 by a hollow, internally-splined input shaft 18. FIG. 2 shows only the upper half of transmission 20. Input shaft 18 is symmetrical about axis 21, as are most of the other rotating members of transmission 20.

Transmission 20 is substantially enclosed by a main case 80. Inside of transmission 20 are the first motor 28 (motor A, on the left in FIG. 2) and second motor 30 (motor B, on the right in FIG. 2), which may be connected by one or more differential gearing mechanisms and one or more torque transfer devices. Second motor 30 is supported within transmission 20 by a stator can 82 and a bearing support 84. In the embodiment shown, the stator can 82 is single tubular stamped housing. Those having ordinary skill in art will recognize other methods of manufacturing the stator can 82.

Stator can 82 holds the stationary components of second motor 30, and the bearing support 84, through one or more bearings 86, carries the rotating components of second motor 30. Stator can 82 is welded to bearing support 84 at a weld region 90, fixing the two members together for common torque transfer.

The fully assembled second motor 30 is mated to the transmission 20 by bolting the bearing support 84 to the main case 80 with one or more bolts 88. This allows separate assembly of the components (discussed in more detail with reference to FIG. 3) of second motor 30 prior to assembly of transmission 20. Furthermore, second motor 30 may be substantially assembled and tested prior to transmission assembly, as bolts 88 allow the whole second motor 30 assembly to simply be bolted to a test fixture for pre-installation testing.

FIG. 3 shows a more-detailed cross section of a portion of the second motor 30 shown schematically in FIG. 2. Stator can 82 is welded to bearing support 84 at weld region 90, and bearing support 84 is attached to the main case 80 by bolts 88.

Two or more seals 92 further interact with the main case 80 and stator can 82 to define a pressure cavity 94 into which lubricating and cooling fluid may be pumped. Fluid flows from the pressure cavity 94 through one or more cooling holes 96 into the interior of stator can 82, where the fluid cools and lubricates the functional elements of motor 30; such as a stator and windings 98 and a rotor and rotor hub 100.

The rotor and rotor hub 100 are carried against bearing support 84 by bearings 86, which are held in place by one or more snap rings 102. The stator and windings 98 are pressed into the stator can 82 along a tubular portion thereof. Second motor 30 may be connected to the battery 32 and control system 34 by an interface hub 104 mounted in the main case 80.

From a manufacturing perspective, this design allows the second motor 30 stator and windings 98 to be pressed into the stator can 82 and bearing support 84 assembly first. The rotor and rotor hub 100 and ball bearings 86 may then be installed and held in the second motor 30 with the snap rings 102. Because of this, the whole second motor 30 (motor B) assembly can be installed as one substantially complete module into the transmission main case 80 instead of installing individual components. Furthermore, this design also allows for the second motor 30 assembly to be fully tested prior to installation into the main case 80.

While the best modes for carrying out the claimed invention have been described in detail, those familiar with the art to which this invention relates will recognize various alternative designs and embodiments for practicing the invention within the scope of the appended claims.

1. A motor/generator for a hybrid transmission substantially enclosed by a transmission main case, comprising:
a bearing support configured for rigid attachment to the transmission main case;
a stator can; and
wherein said stator can is bonded directly to said bearing support.

2. The motor/generator of claim 1, wherein said stator can is directly bonded to said bearing support by welding.

3. The motor/generator of claim 2, further comprising:
a stator;
wherein said stator can further includes a tubular portion configured to receive said stator; and
wherein said tubular portion is formed from a single piece of material.

4. The motor/generator of claim 3, wherein said stator is press-fit into said tubular portion of said stator can.

5. The motor/generator of claim 4, wherein said tubular portion is a tubular stamping.

6. The motor/generator of claim 1, further comprising:
a stator; and
wherein said stator can further includes a tubular portion configured to receive said stator and formed by tubular stamping.

7. The motor/generator of claim 6, wherein said stator is press-fit into said tubular portion of said stator can.

8. A method of manufacturing a hybrid transmission, comprising:
welding a stator can directly to a bearing support, forming a motor/generator housing;
pressing a stator into said motor/generator housing; and
assembling a substantially-complete motor/generator by installing a rotor, a rotor hub, and a ball bearing into said motor/generator housing.

9. The method of claim 8, further comprising rigidly attaching said substantially-complete motor/generator to a transmission main case.

10. The method of claim 9, further comprising testing said substantially-complete motor/generator prior to rigidly attaching said substantially-complete motor/generator to said transmission main case.

11. The method of claim 1O, wherein said rotor, rotor hub, and ball bearing are held in said motor/generator housing with a snap ring.

12. The method of claim 9, further comprising:
assembling said substantially-complete motor/generator at a first facility;
transporting said substantially-complete motor/generator to a second facility; and
wherein said rigidly attaching said substantially-complete motor/generator to said transmission main case occurs at said second facility.

13. The method of claim 12, further comprising testing said substantially-complete motor/generator prior to rigidly attaching said substantially-complete motor/generator to said transmission main case at said second facility.
